(19) United States
(12) Patent Application Publication
(10) Pub. No.: US 2019/0136550 A1
(43) Pub. Date: May 9, 2019

(54) DRYWALL REPAIR TOOL

(71) Applicant: Consortia Development, Inc., Reno, NV (US)

(72) Inventors: Michael G. Fisher, Reno, NV (US); Kenneth D. Johannaber, Reno, NV (US); Patrick M. Fisher, Reno, NV (US)

(73) Assignee: Consortia Development, Inc., Reno, NV (US)

(21) Appl. No.: 15/807,142

(22) Filed: Nov. 8, 2017

(51) Int. Cl. E04F 21/32; E04F 21/06

(52) U.S. Cl. CPC E04F 21/32; B25G 3/12; E04F 21/06

(57) ABSTRACT

A drywall repair and texturing system includes a holder, a putty knife coupled with the holder, and a texture pad coupled with the holder. In some embodiments, the putty knife and/or the texture pad are removably coupled with the holder. The holder has a main body with a first end and a second end, and a texture pad connector disposed between the first and second ends. The putty knife has a handle, a first connector for attaching to the first end of the main body, a second connector for attaching to the second end of the main body, and a first knife end having a first width. The texture pad has a textured surface and connectors for coupling the texture pad with the texture pad connector.

### FIELD

This application relates generally to hand tools and more specifically to a drywall repair tool used to apply and shape a repair compound to the surface of a wall or ceiling.

### BACKGROUND

Analysts forecast the multi-billion dollar DIY (“Do-It-Yourself”) home improvement market in the U.S. to grow at a compound annual growth rate of 6% during the period 2017-2021, with product innovation one of the major drivers for the market. Digital media is helping to encourage many people to personally take on home improvement projects, and consumers have access to a wealth of instructional “how-to” videos and television networks and shows dedicated to home repairs and improvement. While the digital instructional video platform is expansive, the right tools and methods are essential for performing cost-effective, successful, and low-stress home repairs, especially for newly indoctrinated do-it-yourselfers.

Drywall repair is a well-known practice but often yields cosmetically unacceptable results. It is very difficult to apply a drywall repair compound to a damaged portion of drywall and texturize that repair area so it matches the adjacent area of a wall or ceiling. A number of tools and methods have been described that attempt to facilitate the application and texture matching of drywall repair compound. One such device, described in U.S. Pat. No. 8,739,421, is a stencil-like tool made from a rigid plastic, with apertures in it. The stencil is meant to be held against the damaged drywall, while the do-it-yourselfer uses a separate tool to apply a drywall repair compound over the stencil-like tool for disbursement of the drywall repair compound through the apertures. U.S. Pat. No. 5,567,999 describes a similar stencil-like tool.

Another method is described U.S. Pat. No. 8,349,110, which directs the do-it-yourselfer through an arduous process of taping off an area adjacent to the damaged drywall area, and somehow applying a non-binding compound within the taped-off area, creating a non-binding patch template, then applying drywall repair compound to the adjacent damaged area with an undefined tool, then removing the non-binding patch template, applying it over drywall repair compound, and rolling over the non-binding patch template with a second undefined tool. This process seems extremely labor intensive and unlikely to work well, as it does not seem to take into account the force of gravity acting on the non-binding compound.

These technologies and other examples have significant drawbacks in terms of convenience, ease of use and effectiveness. Therefore, it would be advantageous to have improved devices, systems and method for drywall repair and texturing.

### BRIEF SUMMARY

In one aspect of the present disclosure, a drywall repair and texturing system includes a holder, a putty knife coupled with the holder, and a texture pad coupled with the holder. In some embodiments, the putty knife, the texture pad or both are removably coupled with the holder. The holder may include a main body having a first end and a second end and a texture pad connector disposed between the first and second ends. In some embodiments, the holder has a U-shape. Also in some embodiments, the texture pad connector is curved. The texture pad connector may include tabs on opposite ends configured to fit through slots on the texture pad. Alternatively or additionally, the texture pad connector may include grooves on opposite ends configured to receive protrusions on the texture pad. Optionally, the system may also include a texture pad connector extender removably couplable with the texture pad connector to accommodate a larger texture pad.

In some embodiments, the putty knife includes a handle, a first connector at or near a first end of the handle for attaching to the first end of the main body of the holder, a second connector at or near a second end of the handle for attaching to the second end of the main body of the holder, and a first knife end extending from the first end of the handle and having a first width. In some embodiments, the first and second connectors are openings, and the first and second ends of the main body of the holder are configured to fit through the openings of the putty knife. The putty knife may also include a second knife end extending from the second end of the handle and having a second width that is greater than the first width. The system may also optionally include an abrasive surface on the texture pad connector and/or the putty knife. This abrasive surface may be used for sanding a repaired drywall surface. In some embodiments, the putty knife attaches to the holder along a longitudinal axis of the holder, and the texture pad attaches to the holder perpendicular to the longitudinal axis.

The texture pad typically includes a textured surface and connectors for coupling the texture pad with the texture pad connector of the holder. In one embodiment, the connectors on the texture pad are flaps that flip up and down. In some embodiments, the system may also include multiple replacement texture pads, where the original texture pad and each of the replacement texture pads has a different textured surface relative to one another.

In another aspect of the disclosure, a method for repairing and texturing drywall on a surface may involve removing a putty knife from a holder, using a first knife end of the putty knife to apply drywall repair material to the surface, and texturing the applied drywall repair material with a texture pad attached to the holder. The method may also involve smoothing the applied drywall repair material on the surface, using a second knife end of the putty knife. In one embodiment, the first knife end is a narrow end, and the second knife end is a wide end. In some embodiments, the method includes reattaching the putty knife to the holder before texturing the applied drywall repair material, where texturing the applied drywall repair material comprises holding the holder via a handle of the reattached putty knife. The method may also include extracting the drywall repair material from a container, using the first blade end.

In one embodiment, removing the putty knife involves pulling the putty knife off of a first end and a second end of the holder. Optionally, the method may further involve removing the texture pad from the holder, attaching a different texture pad to the holder, and texturing the drywall repair material or newly applied drywall repair material with the different texture pad. The method may also involve allowing the applied drywall repair material to dry for at least fifteen minutes. Optionally, the method may further involve removing the texture pad from the holder and sanding the applied drywall repair material with an abrasive surface of the holder. The method may also involve sanding the applied drywall repair material with an abrasive surface of the putty knife.

In yet another aspect of the present application, a putty knife for a drywall repair and texturing system may include a handle, a first connector at or near a first end of the handle for attaching to a first end of a holder, a second connector at or near a second end of the handle for attaching to a second end of the holder, and a first knife end extending from the first end of the handle and having a first width. As mentioned above, in some embodiments, the putty knife may also include a second knife end extending from the second end of the handle and having a second width that is greater than the first width. The putty knife may also include at least one abrasive surface on or near the first knife end and/or the second knife end.

In another aspect of the disclosure, a holder for a drywall repair and texturing system may include a main body having a first end and a second end and a texture pad connector disposed between the first and second ends. The holder may have a U-shape, and the first and second ends of the main body of the holder may be configured to connect with a first connector and a second connector of a putty knife.

In another aspect of the disclosure, a texture pad for a drywall repair and texturing system includes a textured surface and connectors for coupling the texture pad with a texture pad connector of a holder. The connectors may be any suitable connectors, such as but not limited to flaps that flip up and down or slots configured to fit over tabs of the texture pad connector.

In yet another aspect of the disclosure, a drywall repair and texturing kit may include a holder, a putty knife removably coupled with the holder, and multiple texture pads removably attachable to the holder. The holder, putty knife and texture pads may include any of the features described above. In one embodiment, the textured surface of each of the multiple texture pads comprises a different pattern.

These and other aspects and embodiments will be described in further detail below, in relation to the attached drawing figures.

### BRIEF DESCRIPTION OF THE DRAWINGS

FIG. 1A is an assembled, top perspective view of a drywall repair and texturing system, according to one embodiment;

FIG. 1B is an exploded, top perspective view of the drywall repair and texturing system of FIG. 1A;

FIG. 1C is a top perspective view of the drywall repair and texturing system of FIGS. 1A and 1B, with the texture pad removed from the holder;

FIG. 1D is a bottom perspective view of the drywall repair and texturing system of FIGS. 1A-1C, with the texture pad removed from the holder;

FIG. 2A is a top perspective view of the texture pad of the drywall repair and texturing system of FIGS. 1A-1D;

FIG. 2B is a top perspective view of an alternative embodiment of a texture pad for a drywall repair and texturing system;

FIGS. 3A and 3B are two top perspective views of the putty knife of the drywall repair and texturing system of FIGS. 1A-1D;

FIG. 4 is a top perspective view of the holder of the drywall repair and texturing system of FIGS. 1A-1D;

FIG. 5A is a top, partially-exploded, perspective view of the drywall repair and texturing system of FIGS. 1A-1D, with the added optional feature of a texture pad connector extender, for accommodating larger texture pads, according to one embodiment;

FIG. 5B is a top, assembled, perspective view of the drywall repair and texturing system and texture pad connector extender of FIG. 5A;

FIG. 5C is a bottom, exploded, perspective view of the drywall repair and texturing system and texture pad connector extender of FIGS. 5A and 5B, with a large texture pad, according to one embodiment;

FIGS. 6A and 6B are top perspective and bottom perspective views, respectively, of a drywall repair and texturing system, according to an alternative embodiment;

FIG. 7 is a top perspective view of a drywall repair and texturing system including an alternative embodiment of a putty knife;

FIG. 8A is an exploded perspective view of a drywall repair and texturing system, according to another alternative embodiment;

FIG. 8B is a perspective view of the holder of the system of FIG. 8A;

FIGS. 9A and 9B are perspective assembled and perspective exploded views, respectively, of a drywall repair and texturing system, according to another alternative embodiment; and

FIGS. 10A and 10B are perspective assembled and perspective exploded views, respectively, of a drywall repair and texturing system, according to another alternative embodiment.

### DETAILED DESCRIPTION

Disclosed herein are devices, systems and methods for enhancing drywall repair and texture matching. Various embodiments generally include a holder, a putty knife coupled with the holder, and a texture pad coupled with the holder. Thus, one self-contained drywall repair and texturing system may be used for extracting drywall repair compound from a container, spreading the compound on the wall or ceiling to be repaired and texturing the repair compound to match the existing drywall. In some embodiments, the putty knife, the texture pad or both are removable from the holder.

For the purposes of this disclosure, the terms “system” and “drywall repair and texturing system” are used to refer to any combination of one or more drywall repair and/or texturing tools coupled with a holder. The drywall repair and texturing system may also be referred to herein simply as “a drywall tool” or “a drywall repair tool.” Alternatively, any one part of the system—holder, putty knife or texture pad—may be referred to as “a tool” or “a drywall repair tool.” Thus, in general, the words “system,” “device” and “tool” should not be interpreted as limiting the scope of any particular embodiment or of the application in general, as these terms may be used interchangeably.

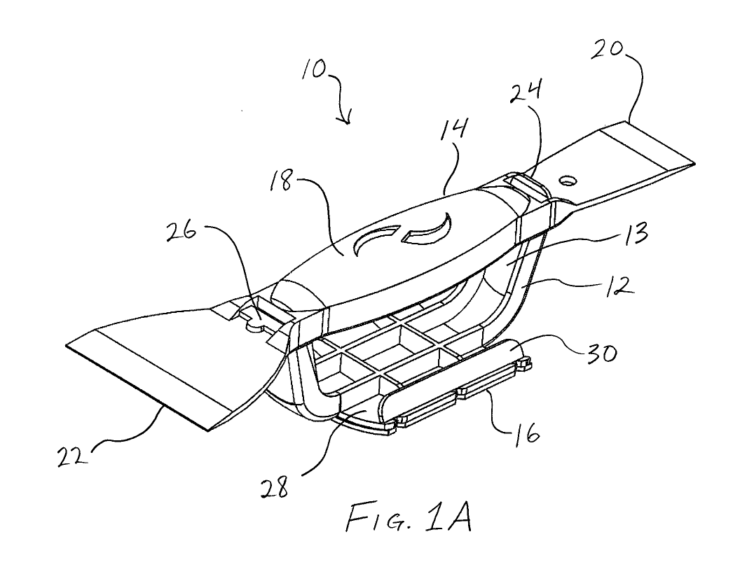

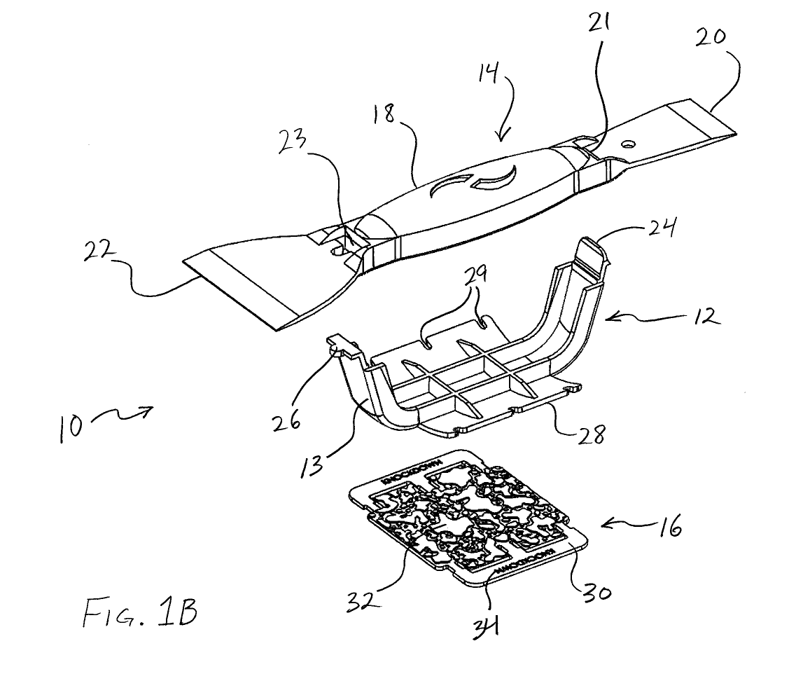

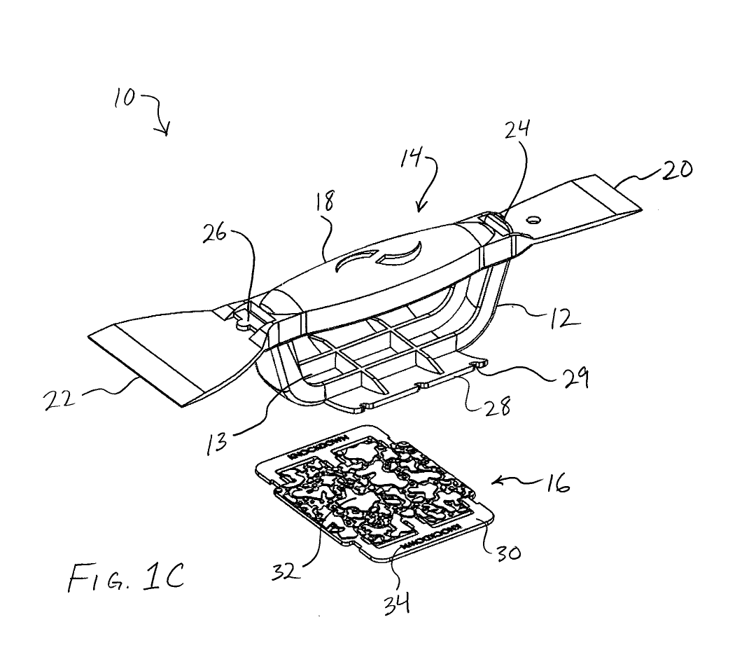

Referring first to FIGS. 1A-1D, in one embodiment, a drywall repair and texturing system 10 may include a holder 12, a putty knife 14 removeably coupled with holder 12, and a texture pad 16 removably coupled with holder 12. In alternative embodiments, putty knife 14 and/or texture pad 16 may be permanently attached to holder 12. In one embodiment, for example, drywall repair and texturing system 10 may be a one-piece, monolithic tool, where none of the parts are removable. In other embodiments, putty knife 14 is removable, and texture pad 16 is a permanent fixture. In yet other embodiments, texture pad 16 is removable, and putty knife 14 is a permanent fixture. Although there are a number of advantages in embodiments with removable putty knives 14 and texture pads 16, the scope of the present application extends to embodiments in which either or both of putty knife 14 and texture pad 16 are permanently attached to, or simply features of, holder 12.

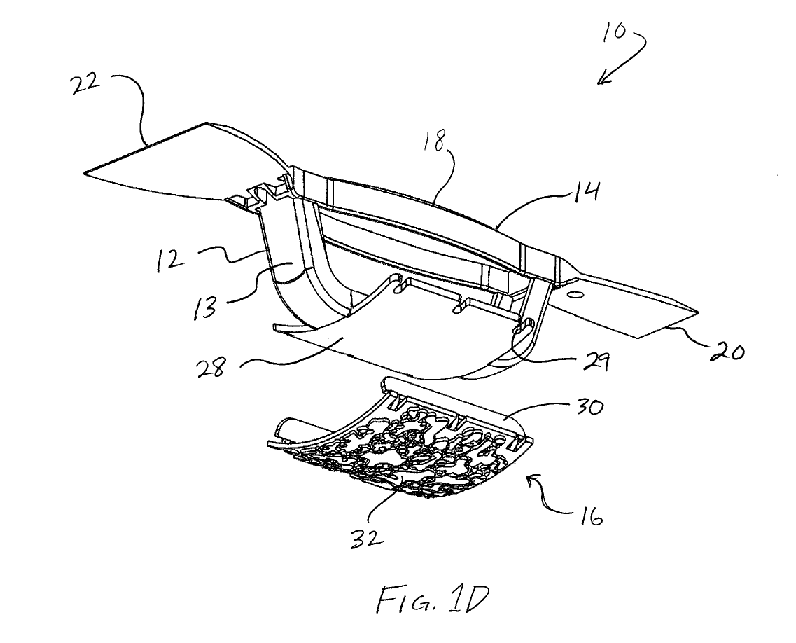

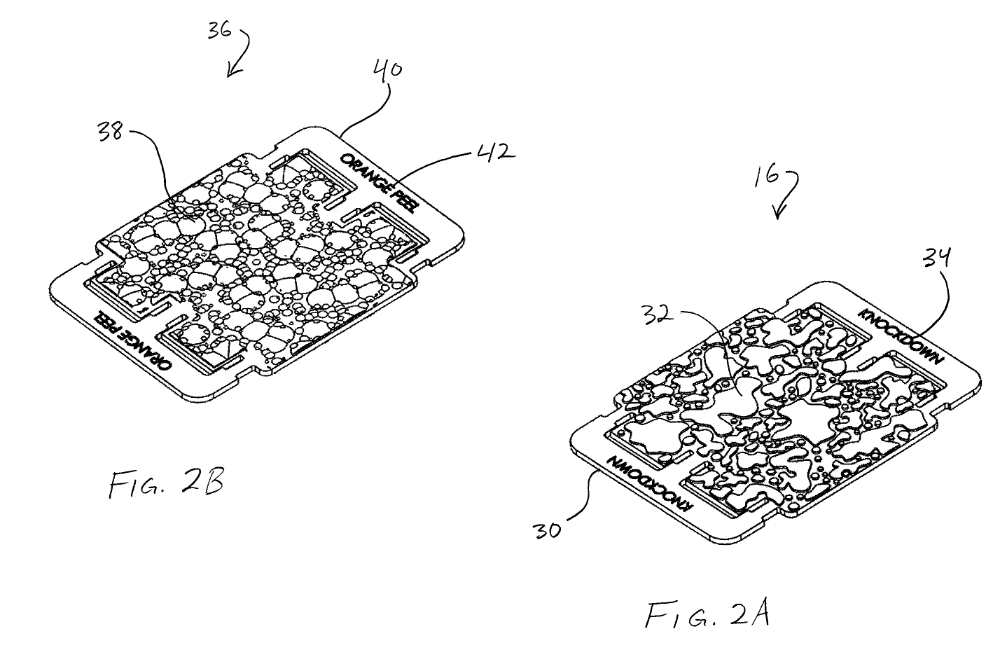

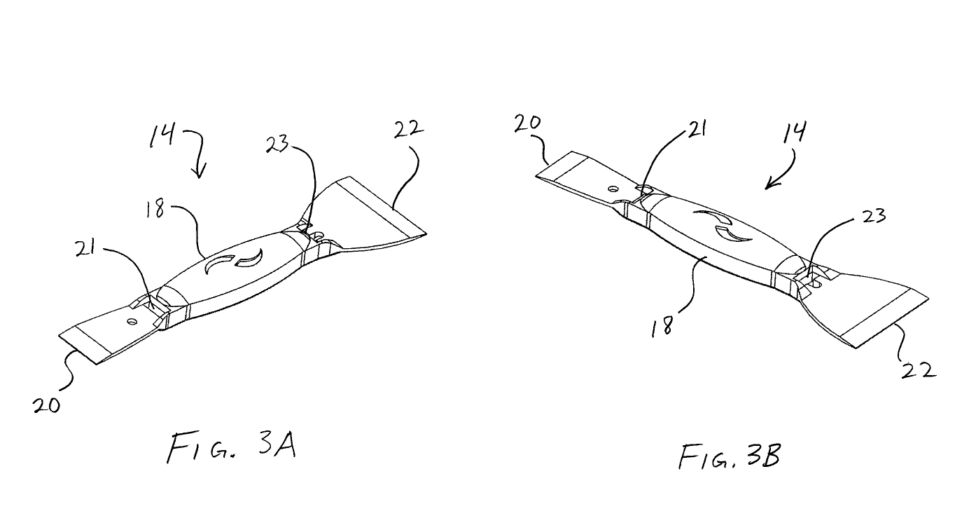

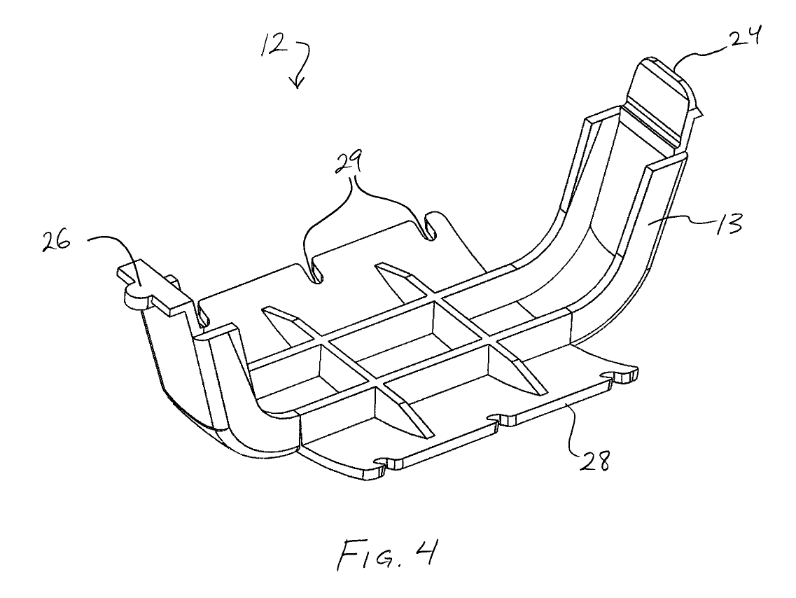

Texture pad 16 is illustrated in further detail in FIG. 2A, with an alternative embodiment of a texture pad 36 being illustrated in detail in FIG. 2B. Putty knife 14 is illustrated in greater detail in FIGS. 3A and 3B. Holder 12 is illustrated in greater detail in FIG. 4.

In the embodiment shown in FIGS. 1A-1D and 4, holder 12 includes a U-shaped main body 13, a first end 24 for connecting with putty knife 14, a second end 26 for connecting with putty knife 14, and a curved texture pad connector 28, which includes multiple grooves 29. Putty knife 14 includes a handle 18, a narrow knife end 20, a wide knife end 22, a first connector 21 for connecting with holder 12, and a second connector 23 for connecting with holder 12. Texture pad 16 includes two connectors 30 at opposite ends of a textured surface 32 and may optionally also include a label 34. At least some of these features are described in further detail below.

As best seen in FIGS. 1B and 4, main body 13 of holder 12 is generally U-shaped. In alternative embodiments, main body 13 may have other shapes, but the U-shape may be advantageous for holding system 10 as a whole. Holder 12 may be a one-piece unit or may be made of multiple attached pieces, according to different embodiments. Holder 12 may be made of any suitable material, such as but not limited to stainless steel, other metals or any suitable plastics. First end 24 and second end 26 may have any suitable shape or combination of shapes to best connect with putty knife 14 via first connector 21 and second connector 23, respectively. In the illustrated embodiment, first end 24 is generally straight and includes a tab on its outward facing surface, and second end 26 has an angled tip with a semi-circular tab. In this embodiment, first end 24 and second end 26 fit through first connector 21 and second connector 23, which in this case are openings on putty knife 14 at opposite ends of handle 18. This is but one example, however. In alternative embodiments, first end 24 and second 26 may have the same shape or may have any other suitable combination of shapes. Additionally, first end 24 and second end 26 may connect with first connector 21 and second connector 23 in any suitable way, according to various embodiments. For example, the connections between holder 12 and putty knife 14 may be via male and female connecting features, with the male and female parts being on other one of holder 12 or putty knife 14. Alternatively, the connections between holder 12 and putty knife 14 may be snap-fit, Velcro, clips, detents, magnets, hooks or any other suitable connecting features on the two components.

Texture pad connector 28 may be thin and curved, as in the illustrated embodiment, or alternatively may have any other suitable shape, such as flat. Any suitable number of grooves 29 may be included, and alternative embodiments may include any additional or alternative features for connecting with texture pad 16. According to various embodiments, holder 12 may be a “universal” holder, which is sized and shaped to fit with many different putty knives and texture pads. Alternatively, holder 12 may be specifically sized and shaped to fit only with a custom putty knife 14 and a custom texture pad 16 included with drywall system 10. FIGS. 1A, 1C and 1D show putty knife 14 attached to holder 12. FIGS. 1A and 1D illustrate how texture pad 16 attaches to holder 12. In this embodiment, connectors 30 on texture pad 16 act as movable flaps to flip over the sides of texture pad connector 28, with tabs on texture pad 16 extending into grooves 29 on connector 28. To remove texture pad 16, connectors 30 can simply be flipped down. In general and in alternative embodiments, holder 12 may have any suitable features, shapes, sizes and configurations designed to attach to putty knife 14 and texture pad 16. As mentioned above, in other alternative embodiments, texture pad 16 and texture pad connector 28 may simply be one piece—i.e., holder 12 includes a non-removable texture pad 16 in such embodiments.

Referring to FIG. 2A, texture pad 16 is shown in greater detail. Texture pad 16 includes connectors 30, textured surface 32, and labels 34, which in this embodiment read “KNOCKDOWN”. Texture pad 16 may be made of a relatively flexible material, so that it may be easily wrapped over the curved surface of texture pad connector 28. The curved surface of texture pad connector 28, and thus the curved textured surface 32 of texture pad 16, may be advantageous for texturing drywall repair compound, in that textured surface 32 may be rolled over the compound. In alternative embodiments, texture pad 16 may fit over and connect with texture pad connector 28 via any suitable connection features. For example, in one embodiment the ends of texture pad 16 may include one or more slots, rather than connectors 30, and the slots may fit over corresponding tabs of texture pad connector. Any other suitable connection features may alternatively or additionally be included.

In one alternative embodiment, illustrated in FIG. 2B, a texture pad 36 may include a different textured surface 38, different or the same connectors 40 and different labels 42, which in this embodiment read “ORANGE PEEL”. In various alternative embodiments, texture pads 16, 36 may include any suitable patterns on their textured surfaces 32, 38 and any labels 34, 42. In some cases, the size, shape and connectors 30, 40 of texture pads 16, 36 may be the same for all embodiments, so that any different embodiment of texture pad 16, 36 will fit on texture pad connector 28. In this way, an infinite number of patterns of textured surfaces 32, 38 may be provided, in order to better accommodate a match between an existing wall or ceiling drywall pattern and a repaired drywall area. In one embodiment, multiple different types/patterns of texture pads 16, 36 may be provided along with holder 12 and putty knife 14 as a kit.

Referring to FIGS. 3A and 3B, as mentioned above, putty knife 14 includes handle 18, narrow knife end 20 and wide knife end 22. Both knife ends 20, 22 are tapered to a knife edge and may be beveled in some embodiments. Either end 20, 22 may be used for extracting drywall repair compound from a container and placing it on a wall or ceiling. Either end 20, 22 may also be used for spreading the compound on the wall or ceiling after the initial application. Connectors 21, 23 are included, which in this embodiment are slot-like openings to accommodate first end 24 and second end 26 of holder 12. Putty knife 14 may be made of any suitable material or combination of materials, such as any suitable metals or plastics. In alternative embodiments, putty knife 14 may have any other suitable shapes, such as but not limited to having two narrow ends 20, two wide ends 22, only one narrow end 20 or only one wide end 22. As mentioned above, in alternative embodiments connectors 21, 23 may be any suitable connectors configured to mate with corresponding connectors on first end 24 and second end 26 of holder 12.

In using the drywall repair and texturing system 10 described above, any of a number of variations and ordering of steps may be used. This description is only one example of a method for using system 10. In one embodiment, putty knife 14 may first be removed from holder 12. The user may hold handle 18 and use narrow knife end 20 of putty knife 14 to extract drywall repair compound from a container and apply the compound to the area of a wall being repaired. The user may then spread the drywall repair compound more smoothly onto the wall, using wide knife end 22 of putty knife 14. Next, the user may reattach putty knife 14 to holder 12. The user may hold onto holder 12 via handle 18 of the reattached putty knife 14 and use texture pad 16 to texture the compound on the wall to match the adjacent, undamaged portion of the wall. For example, in embodiments where texture pad holder 28 is curved, the user may apply texture pad 16 to the repair surface and roll it over the surface. In some embodiments, the user may decide that a different type or pattern of texture pad 16 would be better for a given repair. In that case, the user may remove the first texture pad 16 from holder 12 and replace it with a second one. This may be done at any time and as many times as desired during a given drywall repair project or over multiple projects. Finally, the user may remove putty knife 14 and texture pad 16 from holder 12, clean them, and reattach them to holder 12, if desired. Again, this is only one example of a drywall repair and texturing sequence of events using system 10, and any other number and order of steps may be used for a given project.

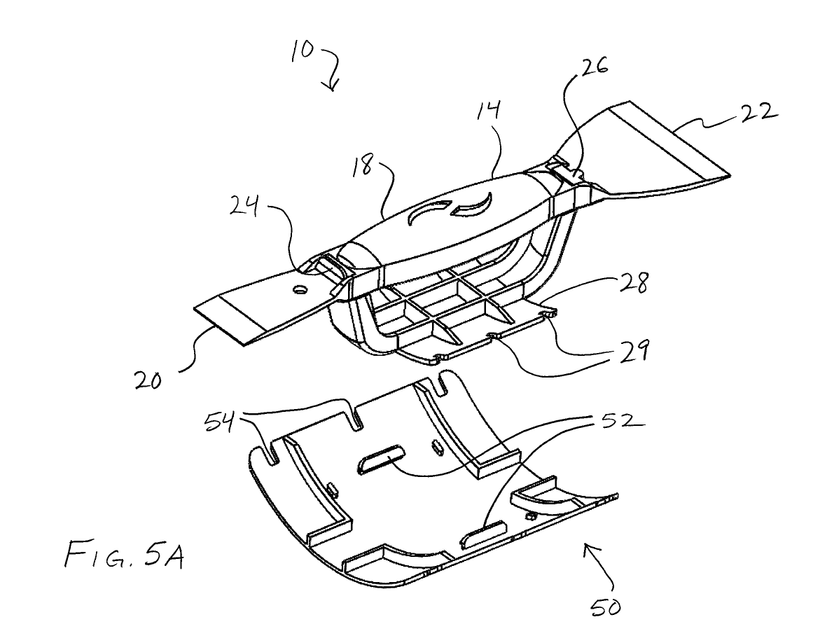

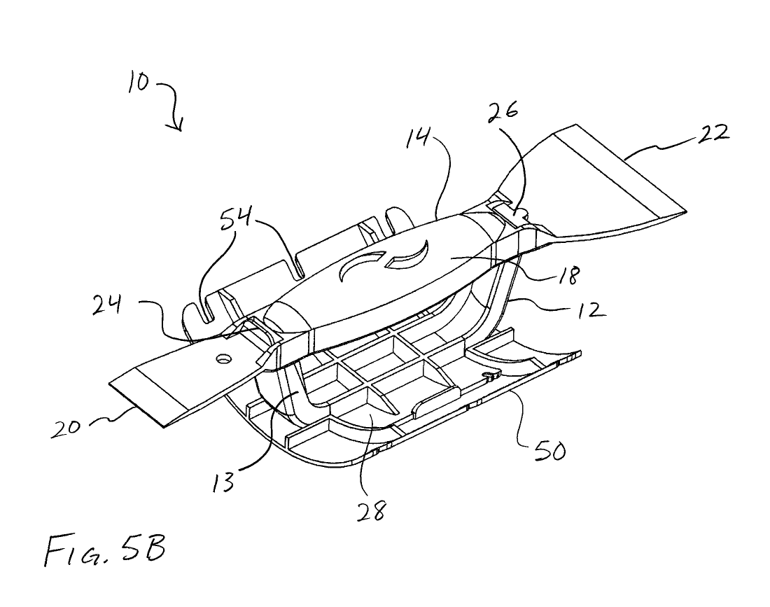

Referring now to FIGS. 5A-5C, an optional feature of drywall repair and texturing system 10 is a texture pad connector extender 50. Extender 50 fits onto texture pad connector 28 of holder 12 and thus allows for a larger texture pad 56 (FIG. 5C) to be coupled with holder 12. Larger texture pad 56 may include a textured surface 58 and connectors 60, similar to or the same as those in previous embodiments, but with a larger size. Extender 50 may fit onto texture pad connector 28 via any suitable mechanism, such as tabs 52 that snap onto corresponding features of connector 28, or alternatively Velcro, snap fit, detents or any other suitable mechanism(s). Extender 50 may also include grooves 54, for fitting similarly with texture pad 56 as was described for previous embodiments. Extender 50 may be attached to holder 12 and removed as desired, and many different shapes and sizes of extenders 50 may be made available as part of system 10.

With reference now to FIGS. 6A and 6B, drywall repair and texturing system 10 may in some embodiments include a different holder 70. Holder 70 may have the same general shape, size and many of the features of the previously described embodiment, but may include a texture pad connector 72 with a textured bottom surface 74. Textured bottom surface 74 may be used for final abrading (or “sanding”) of the repaired drywall area. In this application, drywall system 10 may be referred to as having a longitudinal axis 76, which is the same as the longitudinal axis of putty knife 76. In at least some embodiments, texture pad 16 is attached to texture pad connector 72 in a perpendicular orientation relative to longitudinal axis 76. In other words, the longitudinal axis of texture pad 16 is perpendicular to the longitudinal axis of putty knife 14 when they are both attached to holder 70, at least in some embodiments. Texture pad connector 72 of holder 70 may also be described as having a curvature 78 (or “a radius of curvature”), as illustrated in FIG. 6A. This radius of curvature may be advantageous for allowing texture pad 16 to be rolled over drywall repair compound, as mentioned above.

As illustrated in FIG. 7, in another alternative embodiment, drywall repair and texturing system 10 may include a putty knife 80 that has a handle 82, a narrow knife end 84, and a wide knife end 86 that includes an abrasive surface 88. As with the previous embodiment, abrasive surface 88 may be used for final abrading/sanding of a repaired drywall area. In alternative embodiments, abrasive surface 88 may be on narrow end 84 or on both wide end 86 and narrow end 84.

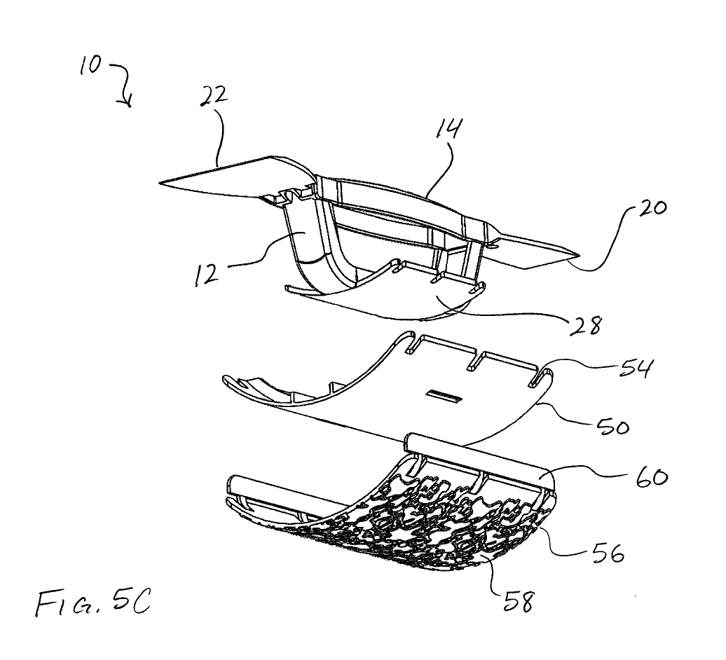

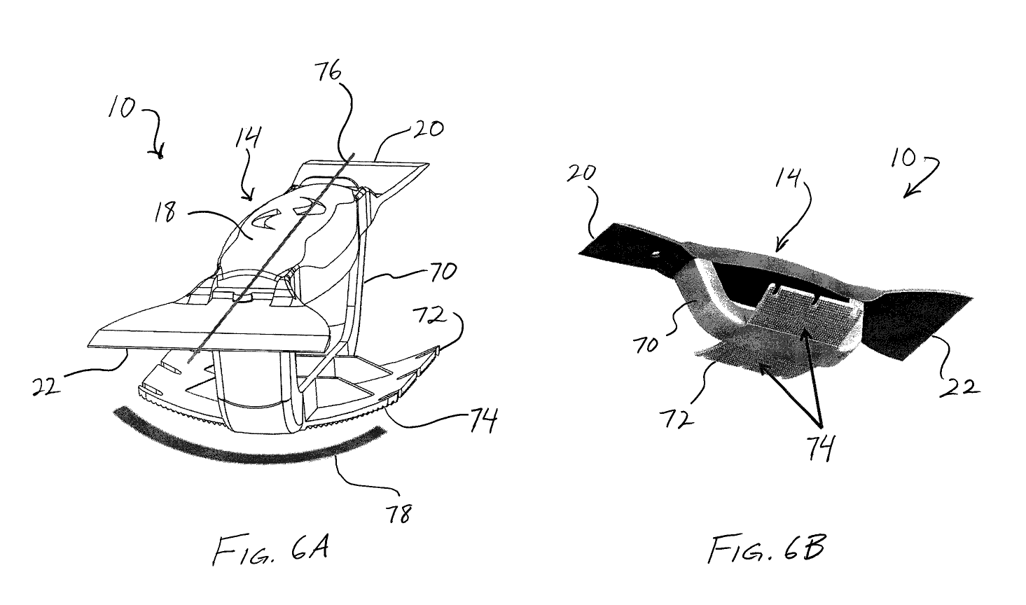

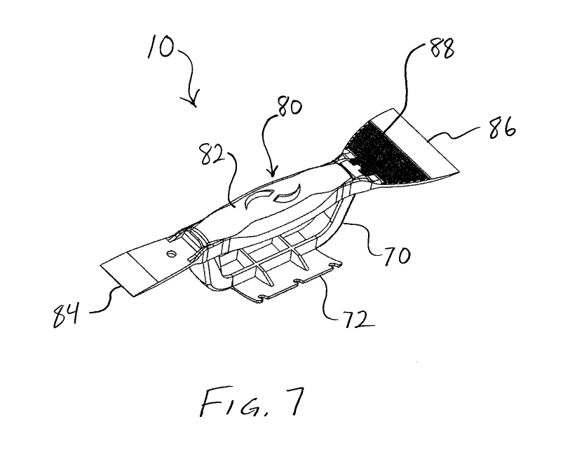

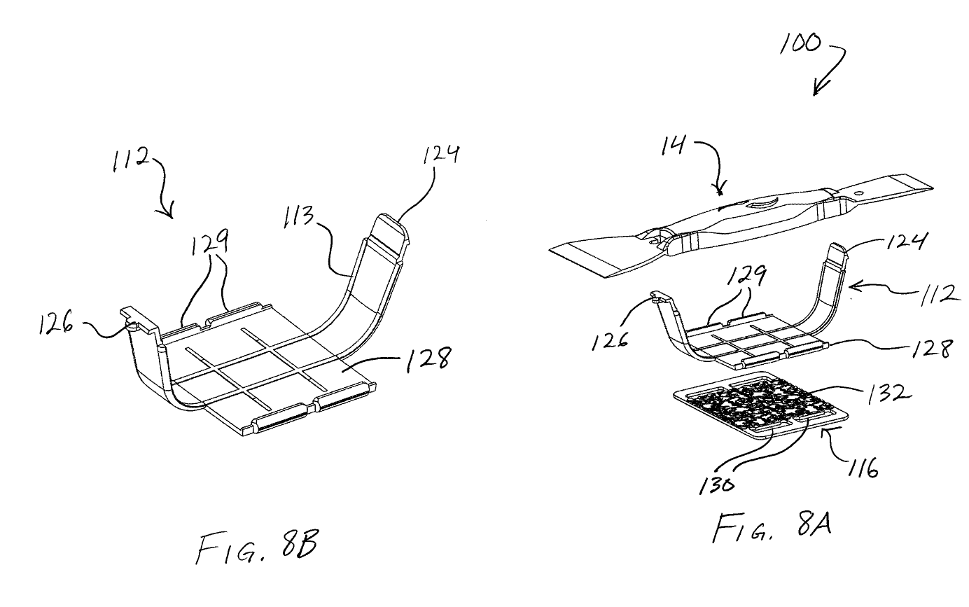

Referring now to FIGS. 8A and 8B, an alternative version of a drywall repair system 100 may include putty knife 14, a different holder 112 and a different texture pad 116. In this embodiment, holder 112 includes a first end 124, a second end 126 and a flat texture pad connector 128. Holder 112 also includes a U-shaped main body 113, and flat texture pad connector 128 includes two tabs 129 at each end for connecting with corresponding slots 130 on texture pad 116. Texture pad 116 includes a textured surface 132, as in previous embodiments. In some embodiments, texture pad 116 may be configured to fit over either a curved texture pad connector 28 (previous embodiments) or flat texture pad connector 128. Using flat texture pad connector 128 and texture pad 116, the user may press the flat textured surface 132 into the drywall repair compound on the wall or ceiling, rather than rolling the surface as in previously described embodiments. In all other respects, system 100 is the same the previously described embodiment of system 10.

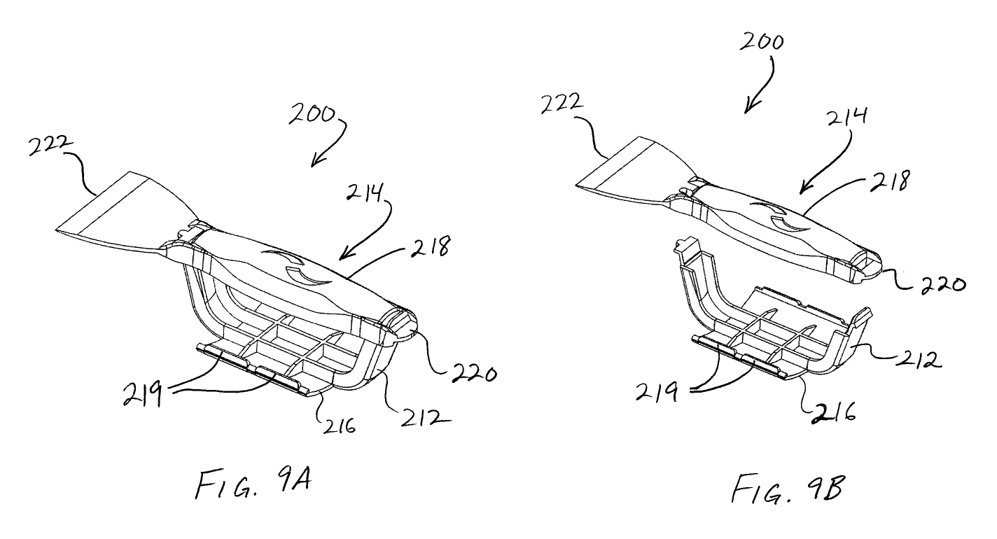

With reference now to FIGS. 9A and 9B, in yet another embodiment, a drywall repair and texturing system 200 may include a holder 212, a putty knife 214, and a texture pad (not shown). Holder 212 may include a texture pad connector 216 with tabs 219. Putty knife 214, in this embodiment, includes a handle 218 and only one blade end, which is a wide knife end 222. The opposite end 220 of handle 218 is a blunt end. In all other respects, system 200 is similar to previous embodiments and may include any of the features described above.

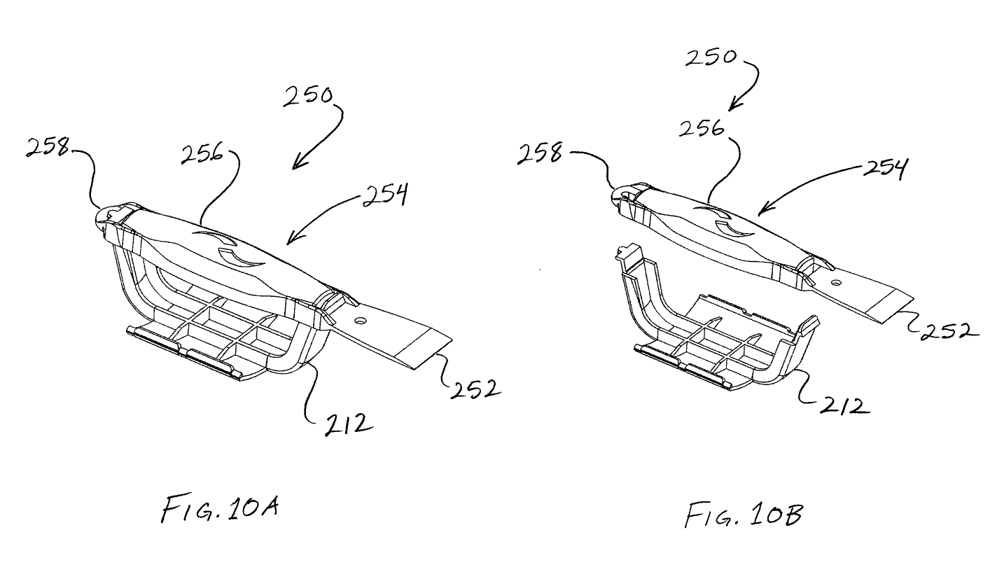

Referring now to FIGS. 10A and 10B, in yet another embodiment, a drywall repair and texturing system 250 may include holder 212 as described above, another alternative embodiment of a putty knife 254, and a texture pad (not shown). Putty knife 254, includes a handle 256 and only one blade end, which in this embodiment is a narrow knife end 252. The opposite end 258 of handle 256 is a blunt end. In all other respects, system 250 is similar to previous embodiments and may include any of the features described above.

Although this description of embodiments and features is thought to be complete and accurate, various alternative embodiments and features, as well as alterations to the embodiments described above, are considered to be within the scope of this application. Thus, the description of certain embodiments and features described above should not be interpreted as limiting the scope of the invention.

I claim:

1. A drywall repair and texturing system, comprising:
a holder;
a putty knife coupled with the holder; and
a texture pad coupled with the holder.

2. The system of claim 1, wherein the putty knife and the texture pad are both removably coupled with the holder.

3. The system of claim 1, wherein the holder comprises:
a main body having a first end and a second end; and
a texture pad connector disposed between the first and second ends.

4. The system of claim 3, wherein the holder has a U-shape.

5. The system of claim 3, wherein the texture pad connector is curved.

6. The system of claim 3, wherein the texture pad connector comprises tabs on opposite ends configured to fit through slots on the texture pad.

7. The system of claim 3, wherein the texture pad connector comprises grooves on opposite ends configured to receive protrusions on the texture pad.

8. The system of claim 3, further comprising a texture pad connector extender removably couplable with the texture pad connector to accommodate a larger texture pad.

9. The system of claim 3, wherein the putty knife comprises:
a handle;
a first connector at or near a first end of the handle for attaching to the first end of the main body of the holder;
a second connector at or near a second end of the handle for attaching to the second end of the main body of the holder; and
a first knife end extending from the first end of the handle and having a first width.

10. The system of claim 9, wherein the first connector comprises a first opening, wherein the second connector comprises a second opening, and wherein the first and second ends of the main body of the holder are configured to fit through the first and second openings of the putty knife.

11. The system of claim 9, wherein the putty knife further comprises a second knife end extending from the second end of the handle and having a second width that is greater than the first width.

12. The system of claim 9, further comprising an abrasive surface on at least one of the texture pad connector or the putty knife, wherein the abrasive surface is configured for sanding a repaired drywall surface.

13. The system of claim 9, wherein the putty knife attaches to the holder along a longitudinal axis of the holder, and wherein the texture pad attaches to the holder perpendicular to the longitudinal axis.

14. The system of claim 3, wherein the texture pad comprises:
a textured surface; and
connectors for coupling the texture pad with the texture pad connector of the holder.

15. The system of claim 14, wherein the connectors on the texture pad comprise flaps that flip up and down.

16. The system of claim 14, further comprising multiple replacement texture pads, wherein the texture pad and each of the replacement texture pads has a different textured surface relative to one another.

17. A method for repairing and texturing drywall on a surface, the method comprising:
removing a putty knife from a holder;
using a first knife end of the putty knife to apply drywall repair material to the surface; and
texturing the applied drywall repair material with a texture pad attached to the holder.

18. The method of claim 17, further comprising smoothing the applied drywall repair material on the surface, using a second knife end of the putty knife.

19. The method of claim 18, wherein the first knife end comprises a narrow end, and wherein the second knife end comprises a wide end.

20. The method of claim 17, further comprising reattaching the putty knife to the holder before texturing the applied drywall repair material, wherein texturing the applied drywall repair material comprises holding the holder via a handle of the reattached putty knife.

21. The method of claim 17, further comprising extracting the drywall repair material from a container, using the first blade end.

22. The method of claim 17, wherein removing the putty knife comprises pulling the putty knife off of a first end and a second end of the holder.

23. The method of claim 17, further comprising:
removing the texture pad from the holder;
attaching a different texture pad to the holder; and
texturing the drywall repair material or newly applied drywall repair material with the different texture pad.

24. The method of claim 17, further comprising allowing the applied drywall repair material to dry for at least fifteen minutes.

25. The method of claim 17, further comprising:
removing the texture pad from the holder; and
sanding the applied drywall repair material with an abrasive surface of the holder.

26. The method of claim 17, further comprising sanding the applied drywall repair material with an abrasive surface of the putty knife.

27. A putty knife for a drywall repair and texturing system, the putty knife comprising:
a handle;
a first connector at or near a first end of the handle for attaching to a first end of a holder;
a second connector at or near a second end of the handle for attaching to a second end of the holder; and
a first knife end extending from the first end of the handle and having a first width.

28. The putty knife of claim 27, further comprising a second knife end extending from the second end of the handle and having a second width that is greater than the first width.

29. The putty knife of claim 28, further comprising at least one abrasive surface on or near at least one of the first knife end or the second knife end.

30. A holder for a drywall repair and texturing system, the holder comprising:
a main body having a first end and a second end; and
a texture pad connector disposed between the first and second ends.

31. The holder of claim 30, wherein the holder has a U-shape.

32. The holder of claim 30, wherein the first and second ends of the main body of the holder are configured to connect with a first connector and a second connector of a putty knife.

33. A texture pad for a drywall repair and texturing system, the texture pad comprising:
a textured surface; and
connectors for coupling the texture pad with a texture pad connector of a holder.

34. The texture pad of claim 33, wherein the connectors on the texture pad comprise flaps that flip up and down.

35. The texture pad of claim 33, wherein the connectors on the texture pad comprise slots configured to fit over tabs of the texture pad connector.

36. A drywall repair and texturing kit, comprising:
a holder, comprising:
a main body having a first end and a second end; and
a texture pad connector disposed between the first and second ends a putty knife removably coupled with the holder, the putty knife comprising:
a handle;
a first connector at or near a first end of the handle for attaching to the first end of the main body of the holder;
a second connector at or near a second end of the handle for attaching to the second end of the main body of the holder; and
a first knife end extending from the first end of the handle and having a first width; and
multiple texture pads removably attachable to the holder, wherein each of the multiple texture pads comprises:
a textured surface; and
connectors for coupling with the texture pad connector of the holder.

37. The kit of claim 36, wherein the putty knife further comprises a second knife end extending from the second end of the handle and having a second width that is greater than the first width.

38. The kit of claim 36, further comprising an abrasive surface on at least one of the texture pad connector or the putty knife, wherein the abrasive surface is configured for sanding a repaired drywall surface.

39. The kit of claim 36, wherein the textured surface of each of the multiple texture pads comprises a different pattern.
